(19) United States
(12) Patent Application Publication
(10) Pub. No.: US 2013/0133008 A1
(43) Pub. Date: May 23, 2013

(54) APPARATUS AND METHOD FOR VIRTUAL BROADCASTING

(71) Applicant: Samsung Electronics Co., Ltd, Gyeonggi-do (KR)

(72) Inventors: Kwang-Min Kim, Gyeonggi-do (KR); Nam-Hoon Kim, Gyeonggi-do (KR); Mu-Hong Byun, Gyeonggi-do (KR); Joon-Seop Oh, Gyeonggi-do (KR); Young-Min Won, Gyeonggi-do (KR); Moon-Sang Lee, Gyeonggi-do (KR)

(73) Assignee: Samsung Electronics Co., Ltd, Gyeonggi-do (KR)

(21) Appl. No.: 13/682,678

(22) Filed: Nov. 20, 2012

(30) Foreign Application Priority Data
Nov. 23, 2011 (KR) 10-2011-0122967

(51) Int. Cl. H04N 21/2385

(52) U.S. Cl. CPC H04N 21/2385
USPC 725/56; 725/95

(57) ABSTRACT

An apparatus and method provide virtual broadcasting. A method of server operation for virtual broadcasting includes receiving a request for creation of a virtual broadcasting channel meeting a specific required condition from a first client, identifying a virtual group meeting the specific required condition, analyzing log data of second clients within the virtual group and, based on the analyzed result, providing broadcasting information meeting the specific condition, to the first client.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Nov. 23, 2011 and assigned Serial No. 10-2011-0122967, the contents of which are herein incorporated by reference.

### TECHNICAL FIELD OF THE INVENTION

The present disclosure generally relates to a broadcasting system and specifically to a system constructing a broadcasting channel.

### BACKGROUND OF THE INVENTION

The growth of Television (TV) is going on from a web TV using Internet contents and two-way service and an Internet Protocol (IP) TV to a smart TV capable of mounting an operating system in itself and enjoying Web surfing, Web store, various contents and the like.

After the launch of smart TV, a service of a form of gathering detailed information about a TV program that is being currently viewed through a network connected with the smart TV is being provided.

Also, there is being provided a technology in which a leading contents provider recommends a program suitable to a user. For example, an online Video on Demand (VOD) service enterprise is providing a function of recommending a VOD enough for a user to view based on a VOD service history of the user.

These services are providing a function of gathering view histories/service use histories of a user through user log-in and the like and, based on these histories, making a recommendation of new contents to the user. But, the services cannot provide a function of making an active recommendation of contents according to users' tastes changeable at any time. Also, the services cannot make a suitable contents recommendation to a user until before a contents use history of the user is collected to some degree.

Accordingly, a broadcasting apparatus and method for providing a virtual broadcasting channel according to a user demand are needed.

### SUMMARY OF THE INVENTION

To address the above-discussed deficiencies of the prior art, it is a primary object to provide at least the advantages below. Accordingly, one aspect of the present disclosure is to provide a broadcasting apparatus and method for providing a virtual broadcasting channel according to a user demand.

Another aspect of the present disclosure is to provide a broadcasting system for providing a virtual broadcasting channel according to a user demand.

The above aspects are achieved by providing an apparatus and method for virtual broadcasting.

According to one aspect of the present disclosure, a method of server operation for virtual broadcasting is provided. The method includes receiving a request for creation of a virtual broadcasting channel meeting a specific required condition from a first client, deciding a virtual group meeting the specific required condition, analyzing log data of second clients within the virtual group and, based on the analyzed result, providing broadcasting information meeting the specific condition, to the first client.

According to another aspect of the present disclosure, a method of client operation for virtual broadcasting is provided. The method includes sending a request for creation of a virtual broadcasting channel meeting a specific required condition, to a server, receiving broadcasting information meeting the specific required condition, from the server, selecting a corresponding broadcasting channel based on the received broadcasting information, and receiving a broadcasting signal through the corresponding broadcasting channel.

According to a further aspect of the present disclosure, a server apparatus for virtual broadcasting is provided. The apparatus includes a condition manager and a channel manager. The condition manager receives a request for creation of a virtual broadcasting channel meeting a specific required condition from a first client, and decides a virtual group meeting the specific required condition. The channel manager analyzes log data of second clients within the virtual group and, based on the analyzed result, provides broadcasting information meeting the specific condition, to the first client.

According to a yet another aspect of the present disclosure, a client apparatus for virtual broadcasting is provided. The apparatus includes a virtual channel requester, a virtual channel receiver, and a controller. The virtual channel requester sends a request for creation of a virtual broadcasting channel meeting a specific required condition, to a server. The virtual channel receiver receives broadcasting information meeting the specific required condition, from the server. The controller selects a corresponding broadcasting channel based on the received broadcasting information, and receives a broadcasting signal through the corresponding broadcasting channel.

According to a further another aspect of the present disclosure, a method for controlling virtual broadcasting is provided. The method includes, while an electronic device with a touch sense display is in a virtual broadcasting channel view state, displaying at least one or more icons associated with broadcasting information meeting a specific required condition, on the touch sense display, detecting a contact on the touch sense display and, when the detected contact corresponds to a corresponding icon on the touch sense display, displaying a virtual broadcasting channel mapped to the corresponding icon.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a virtual broadcasting system according to an exemplary embodiment of the present disclosure;

FIG. 2 illustrates a block diagram of a virtual broadcasting apparatus according to an exemplary embodiment of the present disclosure;

FIG. 3 illustrates a diagram of a broadcasting view or contents play screen related to virtual broadcasting according to an exemplary embodiment of the present disclosure;

FIG. 4 illustrates a flowchart of a server process for virtual broadcasting according to an exemplary embodiment of the present disclosure; and

FIG. 5 illustrates a flowchart of a client process for virtual broadcasting according to an exemplary embodiment of the present disclosure.

### DETAILED DESCRIPTION OF THE INVENTION

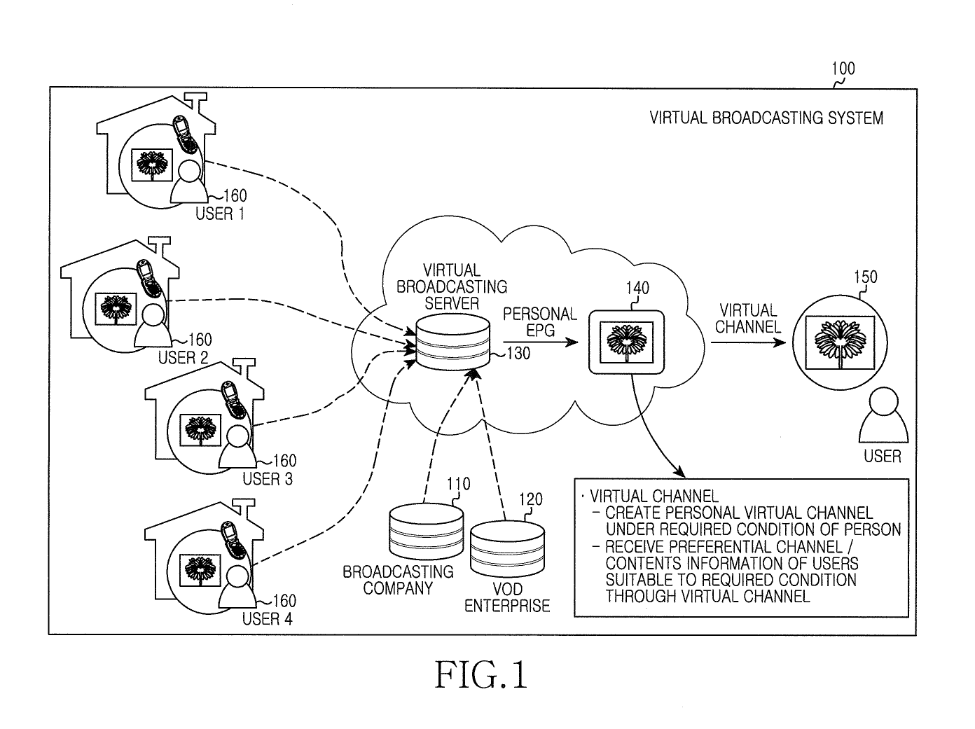

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Preferred embodiments of the present disclosure will be described herein below with reference to the accompanying drawings. In the following description, well-known functions or constructions are not described in detail since they would obscure the invention in unnecessary detail. And, terms described below, which are defined considering functions in the present disclosure, can be different depending on user and operator's intention or practice. Therefore, the terms should be defined based on the disclosure throughout this specification.

More particularly, the present disclosure relates to a system constructing a broadcasting channel according to a required condition of a user.

Below, the present disclosure describes a virtual broadcasting system and method.

Below, the present disclosure defines that virtual broadcasting is broadcasting constructed according to a required condition of a user, and a virtual channel is a channel forwarding the virtual broadcasting.

FIG. 1 illustrates a virtual broadcasting system according to an exemplary embodiment of the present disclosure.

Referring to FIG. 1, the virtual broadcasting system 100 includes a virtual broadcasting server 130, a first client 150 who demands virtual broadcasting, and second clients 160 meeting a condition of the first client 150 who demands the virtual broadcasting. The virtual broadcasting system 100 can further include a broadcasting company 110 for providing broadcasting program information to the virtual broadcasting server 130, and a Video on Demand (VOD) enterprise 120 for providing a VOD view history of a user to the virtual broadcasting, server 130.

The second clients 160 have been registered to the virtual broadcasting server 130 in accordance with a predefined procedure. The second clients 160 report information about their own broadcasting view histories or played contents to the virtual broadcasting server 130 by periods or in response to a request of the virtual broadcasting server 130.

The virtual broadcasting server 130 manages, by a database, information about broadcasting view histories or played contents reported from the second clients 160, broadcasting program related information provided from the broadcasting company 110, and VOD view information provided from the VOD enterprise 120.

Also, when the virtual broadcasting server 130 receives a virtual broadcasting demand from the first client 150 under a required condition of the first client 150, the virtual broadcasting server 130 decides a virtual user group (i.e., second clients 160) meeting the required condition of the first client 150. Then, the virtual broadcasting server 130 provides a virtual broadcasting channel 140 to the first client 150 based on broadcasting view information of the virtual user group or based on broadcasting view histories of the virtual user group, VOD view histories thereof, played contents information thereof and the like. The virtual broadcasting channel 140 is a broadcasting program or contents meeting the required condition of the first client 150.

The first client 150 sending the virtual broadcasting demand transmits the required condition of the first client 150 to the virtual broadcasting server 130, receives broadcasting program or contents information meeting the required condition of the first client 150 from the virtual broadcasting server 130, and views a corresponding broadcasting program or purchases and plays corresponding contents.

As described above, the virtual broadcasting server 130 can create various virtual channels under a required condition of a user and therefore, various information provisions are possible even though a user's taste may change at any time.

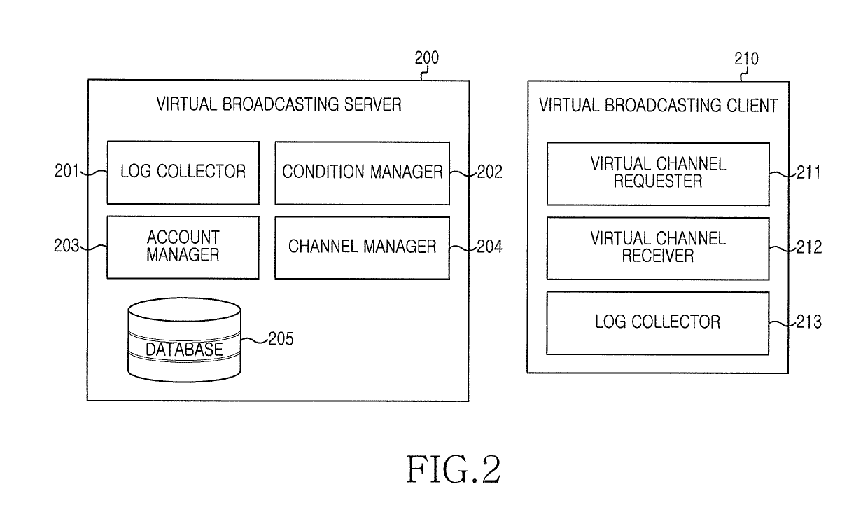

FIG. 2 illustrates a virtual broadcasting apparatus according to an exemplary embodiment of the present disclosure.

Referring to FIG. 2, the virtual broadcasting, apparatus includes a virtual broadcasting server 200 and a virtual broadcasting client 210. The virtual broadcasting server 200 includes a log collector 201, a condition manager 202, an account manager 203, a channel manager 204, and a database 205. The virtual broadcasting client 210 includes a virtual channel requestor 211, a virtual channel receiver 212, and a log collector 213.

A construction of the virtual broadcasting server 200 is described below.

The log collector 201 receives log data reported from a device (e.g., a registered smart TV or smart phone) and stores the log data in the database 205. The log data includes information acquirable from the device, such as state information of the device, operation information of the device, sensing information of the device and the like. When a user (i.e., first client) views broadcasting through the smart TV or plays contents through the mobile phone for the sake of virtual broadcasting, channel information, broadcasting program/contents metadata information and the like can be logged in addition to the device operation information for viewing/playing.

The account manager 203 stores/manages user information and user device information. The user information includes a user IDentifier (ID) capable of distinguishing users, an age, a sex, a family member, an address and the like. The user device information includes a unique ID capable of distinguishing users' devices, characteristic information of the device and the like.

The database 205 stores log data received from a device, user information, and user device information. The data received from the device may be stored in one database or may be stored in respective databases according to the characteristics of the data.

The condition manager 202 creates a virtual group for virtual broadcasting. For example, the condition manager 202 receives a condition designated by a user (i.e., first client) who views the virtual broadcasting, and decides a virtual group of target users or target devices (i.e., second clients) meeting the designated condition.

If the target virtual group is created under the condition made by the user (i.e., first client) who views the virtual broadcasting, the channel manager 204 analyzes log data reported from the devices (i.e., second clients) involved in the created virtual group, creates a personal broadcasting/contents program guide for a virtual channel, and provides the guide to the user (i.e., first client).

A construction of the virtual broadcasting client 210 is described below.

The virtual channel requester 211 sends a virtual channel creation request to the virtual broadcasting server 200 on a condition that the virtual broadcasting user desires for himself/herself. For example, the virtual channel requester 211 sends a virtual channel creation request under a condition that can be made in combination of user information stored in the virtual broadcasting server 200 such as a “channel most viewed by men in their 30s”, a “channel most viewed by people registered as phonebook friends”, a “channel most viewed at home with kindergartener” and the like.

If a virtual channel requested by the virtual broadcasting user is created in the virtual broadcasting, server 200, the virtual channel receiver 212 receives information about the fact that the virtual channel has been created and broadcasting channel information (i.e., program information or contents information) that meets a condition, from the virtual broadcasting server 200. If the virtual broadcasting user requests to view the created virtual channel, the virtual channel receiver 212 plays the virtual channel (i.e., a program or contents) in accordance with the received broadcasting channel (i.e., program information or contents information).

The log collector 213 collects log data such as broadcasting view/contents play information, broadcasting program information, contents metadata information, user information and the like from a device (i.e., first client), and transmits the log data to the virtual broadcasting server 200 by periods or in response to a request of the virtual broadcasting server 200.

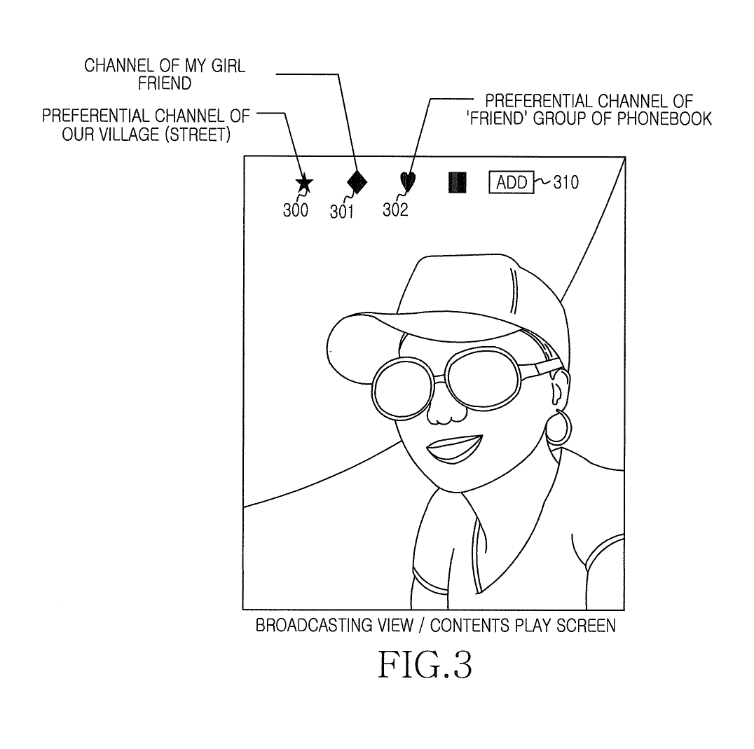

FIG. 3 illustrates a broadcasting view of contents play screen related to virtual broadcasting according to an exemplary embodiment of the present disclosure.

FIG. 3 illustrates a screen on which a user (i.e., first client) selects and plays one of a plurality of broadcasting programs or a plurality of contents (e.g., VODs, images, videos and the like) recommended from a virtual broadcasting server.

The user can show icons 300, 301, and 302 associated with the recommended contents or broadcasting programs for each of a plurality of conditions or a plurality of combinations of the conditions, at the top of the screen. According to realization, the user can show the icons 300, 301, and 302 at the bottom of the screen or at the left/right side thereof.

For example, under corresponding conditions, a preferential channel of our village (300), a channel of my girl friend (301), a preferential channel of a ‘friend’ group stored in a phonebook (302) and the like are shown in a form of icon on the screen. By clicking on the corresponding icon 301, 302, or 303, the user can change the screen. Also, the user can further add a virtual channel through an ‘ADD’ button 310.

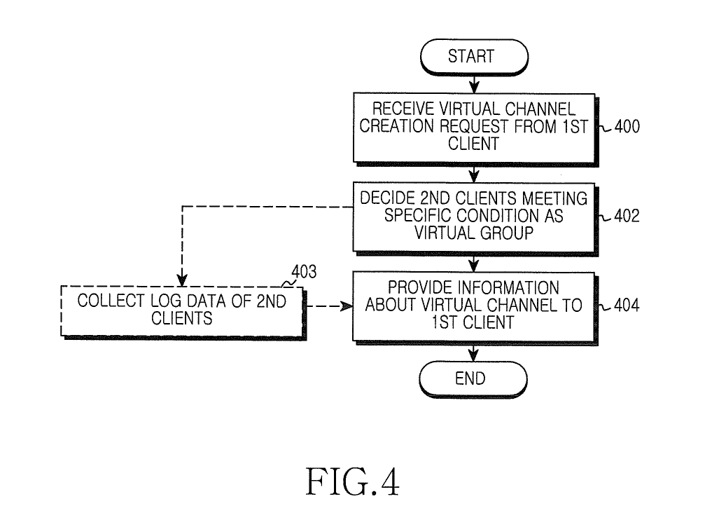

FIG. 4 illustrates a server process for virtual broadcasting according to an exemplary embodiment of the present disclosure.

Referring to FIG. 4, in step 400, the server 200 receives a virtual channel creation request including a specific condition, from a first client. For instance, the server 200 receives a virtual channel creation request from the first client on a condition such as a “channel most viewed by men in their 30s”, a “channel most viewed by people registered as phonebook friends”, a “channel most viewed at home with kindergartener” and the like.

After that, in step 402, the server 200 checks if there are second clients meeting the specific condition among the registered second clients and, if so, the server 200 decides, as a virtual group for virtual broadcasting, the second clients meeting the specific condition.

Meantime, in step 403, the server 200 collects log data reported from the registered second clients by periods or in response to a request to the second clients, respectively. The log data includes information acquirable from a device, such as state information of the device, operation information of the device, sensing information of the device and the like. And, when the first client views broadcasting through a smart TV or plays contents through a mobile phone, the server 200 can collect channel information, broadcasting program/contents metadata information and the like in addition to the device operation information for viewing/playing.

After that, if the virtual group (i.e., second clients) is created under the specific condition made by a virtual broadcasting user (i.e., first client), in step 404, the server 200 analyzes the log data reported from the second clients that are included in the decided virtual group, creates a personal broadcasting/contents program guide for a virtual channel, and provides the guide to the virtual broadcasting user (i.e., first client).

Next, the server 200 terminates a procedure of the present disclosure.

The method described above in relation with FIG. 4 under of the present invention may be provided as one or more instructions in one or more software modules, or computer programs stored in an electronic device including the server.

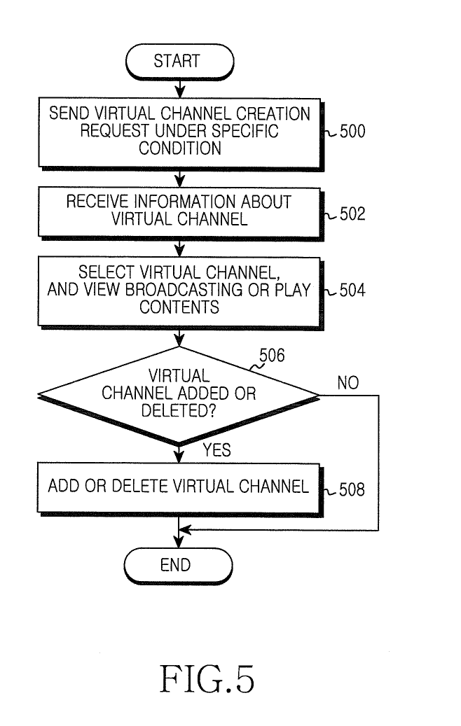

FIG. 5 illustrates a client operation for virtual broadcasting according to an exemplary embodiment of the present disclosure.

Referring to FIG. 5, in step 500, a client 210 sends a virtual channel creation request to a virtual broadcasting server 200 under a condition that a virtual broadcasting user desires for himself/herself. For example, the client 210 sends a virtual channel creation request under a condition that can be made in combination of user information, such as a “channel most viewed by men in their 30s”, a “channel most viewed by people registered as phonebook friends”, a “channel most viewed at home with kindergartener” and the like, stored in the virtual broadcasting server 200.

Next, if a virtual channel requested by the virtual broadcasting user is created in the virtual broadcasting server 200, in step 502, the client 210 receives information about the fact that the virtual channel has been created and broadcasting channel information (i.e., program information or contents information) that meets the condition, from the virtual broadcasting server 200.

Then, in step 504, the client 210 selects one of a plurality of recommended broadcasting channels meeting the condition, and views broadcasting or plays contents.

After that, in step 506, the client 210 determines whether to add a virtual channel on a different condition or delete a corresponding virtual channel. When a virtual channel add/delete event occurs, the client 210 proceeds to step 508 and adds a virtual channel or deletes a corresponding virtual channel.

Next, the client 210 terminates a procedure of the present disclosure.

The method described above in relation with FIG. 5 under of the present invention may be provided as one or more instructions in one or more software modules, or computer programs stored in an electronic device including the client.

Methods according to exemplary embodiments disclosed in claims and/or a specification of the present disclosure can be implemented in hardware, software, or a form of combination thereof.

In case of implementing in software, a computer readable storage medium storing one or more programs (i.e., software modules) can be provided. One or more programs stored in the computer readable storage medium are configured to be executable by one or more processors within an electronic device. One or more programs include instructions for enabling the electronic device to execute the methods according to the exemplary embodiments disclosed in the claims and/or the specification of the present disclosure.

These programs (i.e., software modules or software) can be stored in a Random Access Memory (RAM), a nonvolatile memory including a flash memory, a Read Only Memory (ROM), an Electrically Erasable Programmable ROM (EEPROM), a magnetic disk storage device, a Compact Disk ROM (CD-ROM), a Digital Versatile Disk (DVD) or other optical storage device, and a magnetic cassette. In other examples, the programs can be stored in a memory constructed in a combination of some or all of them. Also, each construction memory may be included in plural.

Further, the programs can be stored in a storage device attachable to an electronic device and accessible through a communication network such as the Internet, an intranet, a Local Area Network (LAN), a Wireless LAN (WLAN), or a Storage Area Network (SAN) or a communication network configured in a combination of them. This storage device can access the electronic device through an external port.

Furthermore, a separate storage device on a communication network may access a portable electronic device.

As described above, exemplary embodiments of the present disclosure have an advantage of, by combining user's various conditions and recommending a broadcasting channel (i.e., a program or contents) close to a user's intention, being capable of increasing a user's satisfaction.

Also, the exemplary embodiments of the present disclosure can reliably provide an additional analysis result such as program rating, content ranking, and user's broadcasting tendency by using broadcasting view/contents play information collected based on user's various conditions.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of server operation for virtual broadcasting, the method comprising:
receiving a request for creation of a virtual broadcasting channel meeting, a specific condition from a first client;
identifying a virtual group meeting the specific condition;
analyzing log data of second clients within the virtual group; and
based on a result of analyzing, the log data, providing broadcasting information meeting the specific condition to the first client.

2. The method of claim 1, wherein the log data comprises at least one of state/operation information of a device, broadcasting channel information, a broadcasting program, and contents metadata.

3. The method of claim 1, wherein the broadcasting information comprises at least one of broadcasting channel information, broadcasting, program information, and contents information.

4. The method of claim 1, further comprising:
receiving periodic reports of the log data from the second clients within the virtual group, respectively; and
storing the received periodic reports of the log data on a per-client basis.

5. A method of client operation for virtual broadcasting, the method comprising:
sending a request for creation of a virtual broadcasting channel meeting a specific condition to a server;
receiving broadcasting information meeting the specific condition from the server;
based on the received broadcasting information, selecting a corresponding broadcasting channel; and
receiving a broadcasting signal through the corresponding broadcasting channel.

6. The method of claim 5, further comprising:
based on the received broadcasting information, selecting corresponding contents;
acquiring the corresponding contents; and
playing the acquired contents.

7. The method of claim 5, wherein the broadcasting information comprises at least one of broadcasting channel information, broadcasting program information, and contents information.

8. The method of claim 5, further comprising:
displaying, on a screen, an icon corresponding to the broadcasting information meeting the specific condition; and
when the icon is selected, displaying the broadcasting information meeting the specific condition, on the screen.

9. The method of claim 5, further comprising sending a periodic report of log data for virtual broadcasting to the server.

10. The method of claim 9, wherein the log data comprises at least one of state/operation information of a device, broadcasting channel information, a broadcasting program, and contents metadata.

11. A server apparatus for virtual broadcasting, the apparatus comprising:
a condition manager configured to receive a request for creation of a virtual broadcasting channel meeting a specific condition from a first client, and identifying a virtual group meeting the specific condition; and
a channel manager configured to analyze log data of second clients within the virtual group and, based on a result of the log data, provide broadcasting information meeting the specific condition to the first client.

12. The apparatus of claim 11, wherein the log data comprises at least one of state/operation information of a device, broadcasting channel information, a broadcasting program, and contents metadata.

13. The apparatus of claim 11, wherein the broadcasting information comprises at least one or more of broadcasting channel information, broadcasting program information, and contents information.

14. The apparatus of claim 11, further comprising:
a log collector configured to receive periodic reports of the log data from the second clients within the virtual group, respectively; and
a database configured to store the received log periodic reports of the log data on a per-client basis.

15. A client apparatus for virtual broadcasting, the apparatus comprising:
a virtual channel requester configured to send a request for creation of a virtual broadcasting channel meeting a specific condition to a server;
a virtual channel receiver configured to receive broadcasting information meeting the specific condition from the server; and
a controller configured to, based on the received broadcasting information, select a corresponding broadcasting channel, and receive a broadcasting signal through the corresponding broadcasting channel.

16. The apparatus of claim 15, wherein the controller is configured to:
based on the received broadcasting information, select corresponding contents;
acquire the corresponding contents; and
play the acquired contents.

17. The apparatus of claim 15, wherein the broadcasting information comprises at least one of broadcasting channel information, broadcasting program information, and contents information.

18. The apparatus of claim 15, wherein the controller is configured to:
display, on a screen, an icon corresponding to the broadcasting information meeting the specific condition, and
in response to a selection of the icon, display the broadcasting information meeting the specific condition on the screen.

19. The apparatus of claim 15, further comprising a log collector configured to send a periodic report of log data for virtual broadcasting to the server.

20. The apparatus of claim 19, wherein the log data comprises at least one of state/operation information of a device, broadcasting channel information, a broadcasting program, and contents metadata.

21. A method for controlling virtual broadcasting, the method comprising:
while an electronic device with a touch sense display is in a virtual broadcasting channel view state, displaying at least one or more icons associated with broadcasting information meeting a specific required condition, on the touch sense display;
detecting a contact on the touch sense display; and
when the detected contact corresponds to a corresponding icon on the touch sense display, displaying a virtual broadcasting channel mapped to the corresponding icon.

22. The method of claim 21, further comprising generating at least one icon associated with the broadcasting information meeting the specific required condition on the touch sense display.

23. The method of claim 22, wherein generating the at least one icon associated with the broadcasting information meeting the specific required condition on the touch sense display comprises:
sending a request for generation of a virtual broadcasting channel meeting a plurality of specific required conditions to a server;
receiving broadcasting information meeting the plurality of specific required conditions from the server; and
mapping the plurality of icons with the broadcasting information meeting the plurality of specific required conditions.
